(19) United States
(12) Patent Application Publication
(10) Pub. No.: US 2005/0040038 A1
(43) Pub. Date: Feb. 24, 2005

(54) Diagnostic electro-chemical reference half cell

(76) Inventors: Larry Berger, Yorba Linda, CA (US); Magdalena Durghinescu, Laguna Hills, CA (US); Thomas R. Quirk, Chino, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/815,580

(22) Filed: Mar. 31, 2004

Related U.S. Application Data
(60) Provisional application No. 60/459,717, filed on Apr. 2, 2003.

(51) Int. Cl. G01N 27/26

(52) U.S. Cl. 204/412; 204/415

(57) ABSTRACT

This invention improves the reliability of an Electro-chemical reference half-cell that contains 2 or more electrolyte chambers isolated with porous liquid junctions. The purpose of the reference half-cell is to provide a stable ionic contact to a solution, resulting in the output potential being a function only of the ion specific membrane. In this invention, the primary half-cell is isolated from the process by a second or third electrolyte chamber. In one of the secondary chambers an identical half-cell is inserted to monitor the difference between the primary junction and one of the secondary chambers that are being altered over time. The difference between these two halve cells are monitored and the user is alerted of the degradation of the exposed cell. This indication occurs in advance of significant attack of the primary reference half-cell.

### CROSS REFERENCE TO PRIOR APPLICATIONS

The current application claims priority from US Provisional Patent Application of Ser. No. 60/459,717, of filing date Apr. 2, 2003, the whole of which is incorporated herein by reference.

### BRIEF DESCRIPTION OF THE CURRENT INVENTION

The present invention relates to an Electro-Chemical sensor in general. More specifically, this relates to a sensor capable of the detection and quantification of degradation in a reference cell.

### BACKGROUND OF THE PRIOR ART

In U.S. Pat. No. 6,416,653, which issued on Jul. 9, 2002, inventors T. Barben, II and H. Mitchell disclose an electrochemical sensor with an improved salt bridge. Hess et al describe a similar invention in U.S. Pat. No. 5,630,921, which issued on May 20, 1997. In U.S. Pat. No. 6,054,031 (of issue date Apr. 25, 2000), inventor B. W. Benton described a sensor comprising concentric tubes wherein the cavity between the tubes comprises an ionic junction.

Inventors K. W. Christner and S. Thoeni disclose a sensor with an ion-impermeable spiral cut plug, in U.S. Pat. No. 5,346,606, issued on Sep. 13, 1994. In U.S. Pat. No. 5,540,827, which issued on Jul. 30, 1996, inventors M. E. Deacon and W. F. Gottermeier described an electrochemical sensor containing a directional flow ion-junction bridge.

None of these references, or any others known to be present in the prior art, disclose the invention herein described and presented.

### SUMMARY OF THE INVENTION

Previously, many types of reference cells have been used in endeavoring to provide an effective means to reliably measure the amount of a specific ion, of a discrete chemical species.

For example, in the case of a pH sensor, the specimen ion-sensing electrode can be a hydrogen ion sensitive glass bulb with a millivolt output that varies with the changes in the relative hydrogen ion concentration inside and outside of the bulb. Conversely, the reference cell output does not vary with the activity of the hydrogen ion.

The reference cell is the structure in which most problems can occur within an Electro-Chemical sensor. The reference cell consists of essentially three parts: an internal element such as a metal-metal salt, e.g., AglAgCI, PtIHg.sub.2 CI.sub.2, etc, a filling solution such as an electrolyte, and a liquid junction through which the filling solution contacts the desired specimen to be measured.

Specifically, the reference cell is used to maintain a common electrical potential with the specimen fluid being measured. The filling solution or electrolyte provides the conductive bridge to the specimen fluid and surrounds the reference element with an Electro-Chemically stable environment. In order to obtain an accurate reading, this liquid junction must be in place. In the ideal liquid junction, electrolytic contact between the reference element and specimen fluid would provide the necessary communication, and yet prevent mixing of the specimen fluid with the electrolyte. However, liquid junctions cannot be perfect. This is because contact between the electrolyte and the specimen fluid is present in order for ion flow to occur, and thus mixing can and will ultimately occur.

When the electrolyte mixes with the specimen fluid the defined chemistry surrounding the reference element changes and the stable Electro-chemical environment deteriorates. Users of these sensors could only determine this deterioration by measuring a standard solution and comparing the results with theoretical expectations. In doing this it would determine only that a difference from ideal existed and a process of substitution to determine which element (ion specific, reference or instrumentation) was responsible for the discrepancy. Some users find that it is cost effective to simply replace the measurement elements on a periodic basis to eliminate the labor involved in constantly testing to determine the reliability of the measurement. This is clearly an undesirable situation in that measurement elements may be replaced needlessly, at added cost.

A primary object of the invention is to provide a more reliable reference half-cell to the ion specific Electro-Chemical measurement.

Another important object of the invention is to provide a visual indication of the changes to the internal chemistry of the electrolyte chambers.

Another object of the invention is to improve the life span of the reference half-cell by adding an ionic specific barrier in a forward electrolyte chamber

Still another object of the invention is to warn the operator, of the process, of imminent unreliable measurement before any error actually exists.

Yet another object of the invention is to provide a solution ground for an instrumentation amplifier without having a conductor in direct contact with the measured specimen.

A further object of the invention is to facilitate the ease of replacement of the diagnosed unreliable sensing element.

Yet another object of the invention is the ability to do early or later diagnostic depending on which chamber the diagnostic wire is placed in.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a cross sectional view of the preferred embodiment in accordance with the present invention.

FIG. 2 shows the metal outer housing sheath of the preferred invention.

FIGS. 3-6 are quarterly sections of the overall electronic schematics for the display and control function of the preferred embodiment in accordance with the present invention.

FIG. 7 is an idealized schematic of the preferred embodiment in accordance with the present invention, showing the physical locations of electrodes.

FIG. 8 is FIG. 7 with an added clamber and electrode for monitoring liquid junction potential.

FIG. 9 is a schematic overview of the electronic circuits of the preferred method of invention with an isolated solution ground in accordance with the present invention.

FIG. 10 is a schematic overview of the electronic circuits of the preferred embodiment in accordance with the present invention, with all four half-cells and a metallic solution ground illustrated.

### DETAILED DESCRIPTION OF THE INVENTION

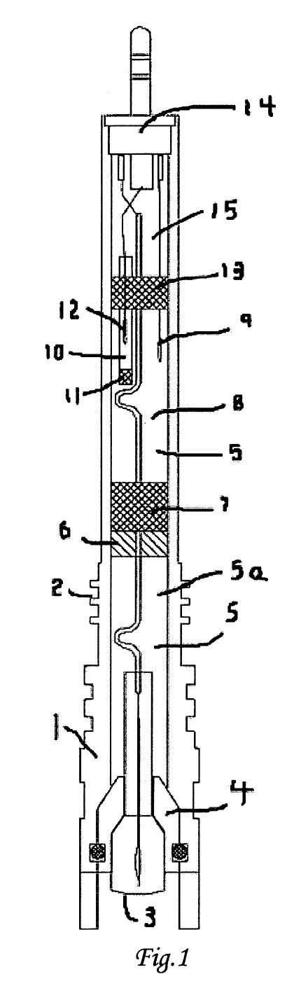

The preferred embodiment for carrying out the invention is diagrammed in FIG. 1, where a cross-sectional view of the Electro-Chemical sensor is shown. The assembly is housed in a cylindrical inert housing body 1 that is chemically compatible with an internal electrolyte as well as with a specimen fluid to be measured. A suitable material having such properties is a poly (aryletherketone), carrying the trade name PEEK or Radel (polyarylsulfone), though other materials may be used as would be known by those having ordinary skill in the art. This housing body 1 has a plurality of acme stub threads 2 that facilitate ease of removal and replacement from the sensor when the sensor is diagnosed as having decreased reliability.

An ion specific membrane 3 is adhered to a semi-permeable first liquid junction 4 to prevent electrolyte, or measured specimen, from flowing in the interface there-between. An assembly consisting of the ion specific membrane 3 and the first liquid junction 4 is inserted into the housing body 1 and adhered to prevent liquid from bypassing the junction at its interface. The cylindrical inert housing body 1 is filled with electrolyte 5 to yield the salt bridge to the specimen fluid. A barrier salt 6 is added to intercept any known ions that will attack reference half-cells of the sensor.

A second liquid junction 7 is placed in the cylindrical inert housing body 1 of the sensor, defining a first electrolyte chamber 5a. A second electrolyte chamber 8 is filled with electrolyte 5 along with a silver wire (Ag, AgCl) 9 to form a diagnostic half-cell. A third chamber 10 with a third liquid junction 11 forming a half-cell 12 is placed in this second chamber 8. This third chamber 10 is the primary reference cell for the Electro-Chemical measurement. An inert plug 13 is used to hold the third chamber 10 and defines the second electrolyte chamber 8. The back of the sensor has a connector 14 inserted to interface with the display electronics and sealed with epoxy 15.

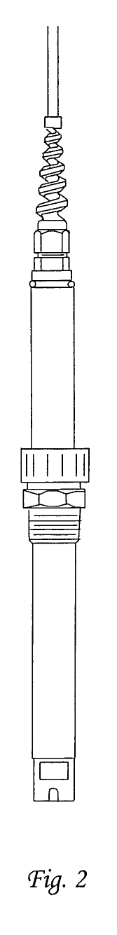

FIG. 2 shows the metal outer housing sheath of the preferred invention. This sheath protects the sensitive electronics in most environments. The sheath can also serve as a grounding element in the electronic circuitry.

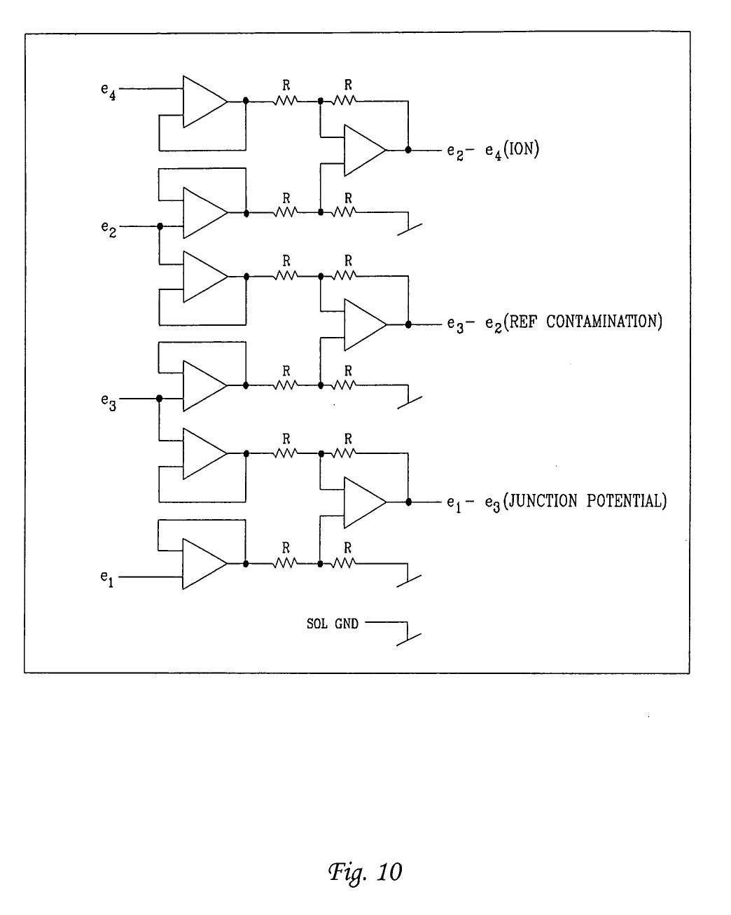

FIG. 10 shows a schematic overview of the electronic circuits of the preferred embodiment in accordance with the present invention. From this it can be simply determined that 4 electrodes give the following information:
The difference between the measured voltages of e₁ and e₃ provide the junction potential.
The difference between the measured voltages of e₃ and e₂ provide the degree of contamination of the reference cell. This is a critical improvement over the prior art, as will be discussed below.
The difference between the measured voltages of e₂ and e₄ provide the ion concentration in the measured sample. This important information is the primary function of the electrochemical sensor.

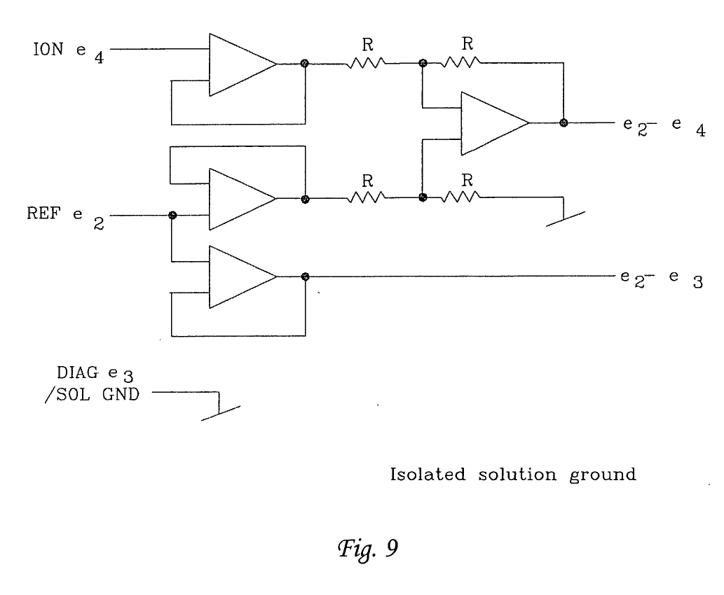

FIG. 9 demonstrates a further improvement offered by the present invention: the ability to function without a direct contact solution ground element. Most commonly, sensors are sheathed in metal containers. When the metal container is inserted in the sample, the metal sheath functions as a ground (“Sol Gnd”).

However, certain process streams are corrosive, or possess other properties that are incompatible with metal sheaths. In this case, the current invention can be sheathed in nonreactive polymer such as described above. In the place of a direct contact ground, the third electrode supplies the solution ground indirectly through the liquid junction. This allows continued junction potential and ion concentration measurement in the absence of a metal sheath, while still employing high impedance instrument amplifiers. The high impedance tends to isolate individual elements of the circuit, thereby minimizing electronic interferences that can cause errors in the measurements.

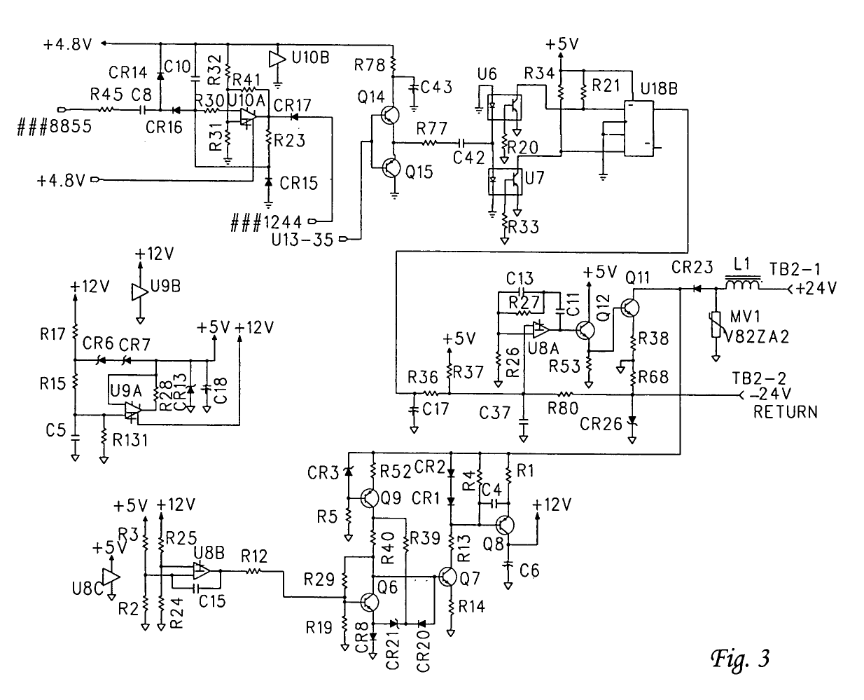

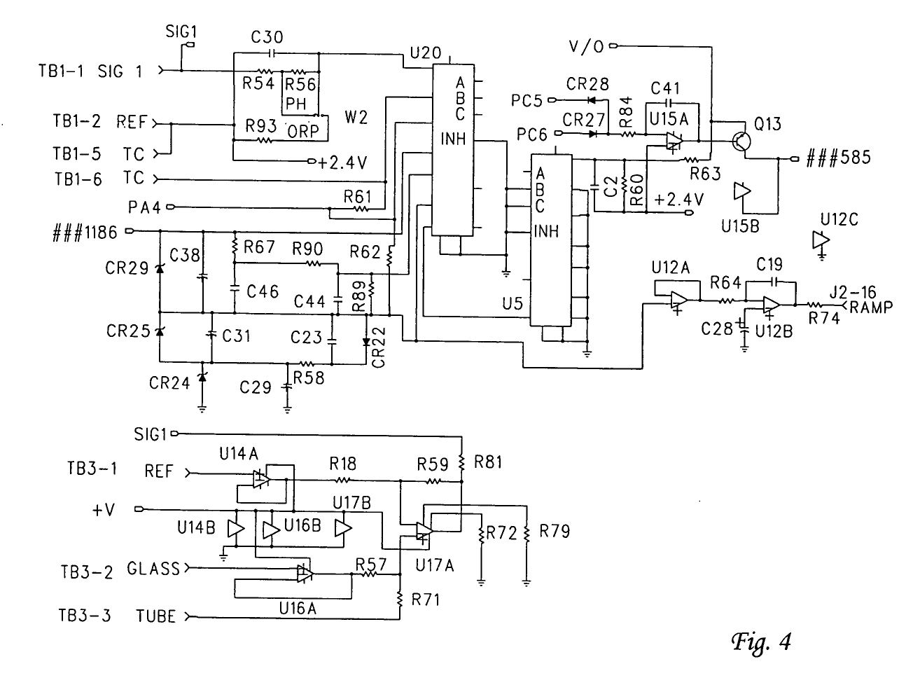

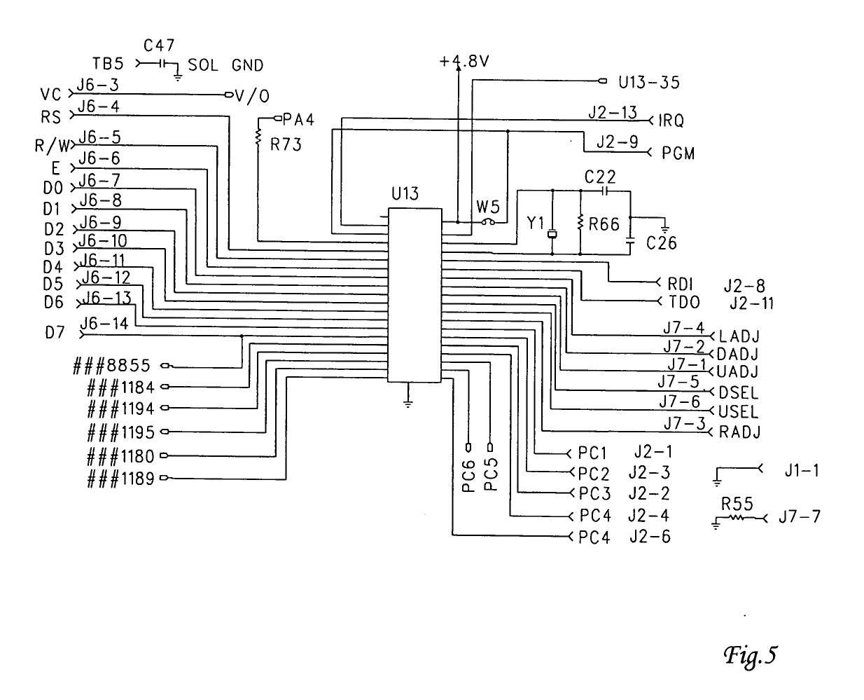

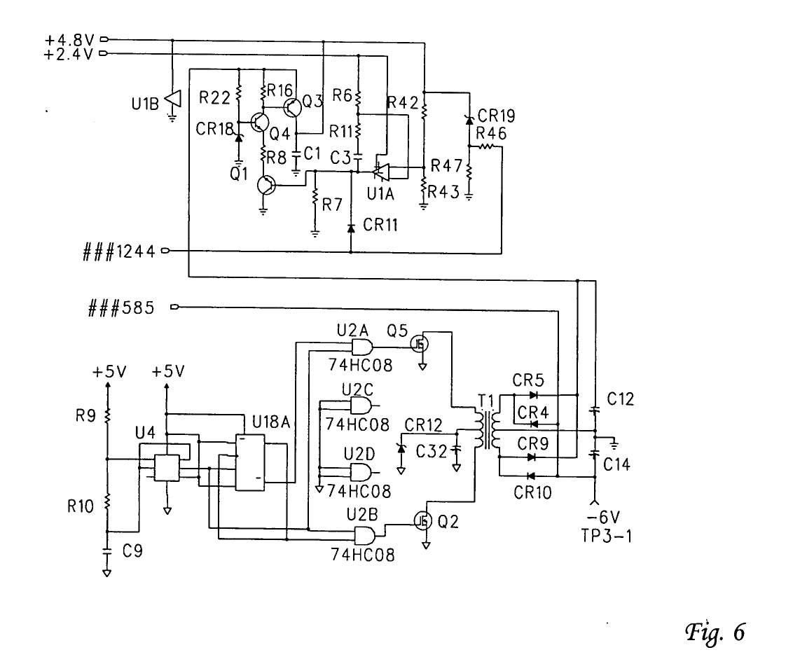

The voltages produced by the above potentials are typically in the millivolt range. To convert these small voltages to useful display information, an electronic amplification and display system is required. A schematic of the electronic diagram of a suitable circuit is shown in FIGS. 3-6. An experienced electrical engineer will note that FIG. 3 and FIG. 4 overlap, and are to be viewed as one large circuit with FIG. 3 on the left, and FIG. 4 on the right side. Similarly, FIG. 5 and FIG. 6 overlap, and are to be viewed as one large circuit with FIG. 5 on the left, and FIG. 6 on the right side. The system takes input from the sensor at connector 14, and converts it to useful visual display information.

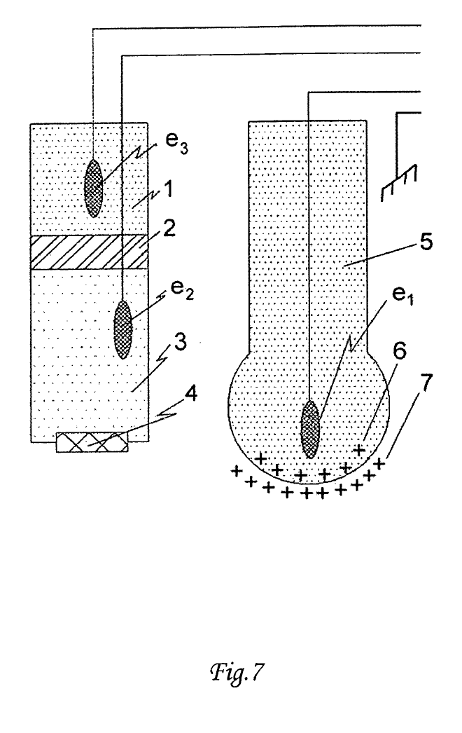

FIG. 7 shows the physical image of the present invention in part. Three of the four electrochemical half cells are visible in this drawing. In FIG. 4, the liquid junction interface 4 lies between the sample to be measured and the measurement cell containing measurement electrode e₂ and the electrolyte 3. Above the measurement cell lies the reference cell, separated by the liquid junction 2. Inside the reference cell is reference electrode e₃ and the electrolyte 1.

On the right side of FIG. 7 is the third electrochemical half cell of the preferred embodiment of the present invention. This cell contains electrode e₁ and the electrolyte 5. Ions 6 are contained within this half cell, while ions 7 are contained without and are the variable to be determined by the measurement.

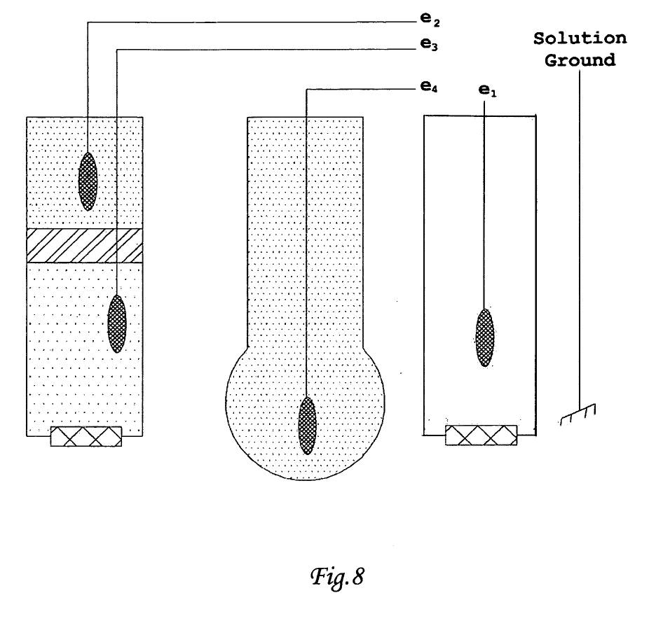

FIG. 8. adds a separate reference half-cell that is used to detect any junction potential that may develop across the liquid junction. This allows for the separate determination of potentials e1, e2, e3, and e4. In this example, e3 is the diagnostic half-cell element.

It can thus be demonstrated that the potential in the diagnostic half-cell can be compared to that in a reference cell. As the potential in the diagnostic half-cell increasingly deviates from that in the reference, it indicates increased half-cell degradation. The deviation is converted to a measure of the degree of half-cell degradation. Such degradation occurs due to dilution, contamination, or other changes to the original chemistry of the half cell.

The electronic circuitry can be programmed to issue an alarm when a certain limit, or level of degradation is reached. Indeed, the system can be fully automated, such that a sensor is removed from the system (or placed off-line) automatically when the limit is attained or exceeded. Also, the visual display indicates the degree of degradation, and an operator can chose manual intervention at an appropriate time.

This method is far superior to existing technology, in which sensor degradation is not even considered or evaluated. There is no clear-cut indicator, as in the present invention, of the best time to change sensor elements before serious degradation takes place, resulting in false readings and erroneous measurements.

While the Invention has been described in complete detail and pictorially shown in the accompanying drawings, it is not to be limited to such details, since many changes and modifications may be made to the invention without departing from the spirit and scope thereof. Hence, it is described to cover any and all modifications and forms, which may come within the language and scope of the appended claims.

1. An electro-chemical sensor comprising:
a plurality of chambers, each filled with an electrolyte;
a plurality of electrodes, one said electrode inserted into each said chamber, thereby forming a plurality of electrochemical half-cells;
at least two liquid junction salt bridges, said bridges separating said chambers from each other and from the sample to be measured;
an ion-specific detection means;
at least one housing over all the above elements;
means for measuring and quantifying the electronic potential of each set of two said half-cells; and,
means to convert said potential measurements into a visual display.

2. A sensor as in claim 1, wherein one said electrochemical half-cell is a designated reference cell, said cell being physically isolated from said sample to be measured, and with voltage potential ideally independent of the concentration of measured ion.

3. A sensor as in claim 1, further comprising at least 3 electrochemical cells.

4. A sensor as in claim 1, wherein one said electrochemical cell is a designated diagnostic half-cell, said cell being connected through at least one salt bridge to the measurement sample.

5. A sensor as in claim 1, wherein one said electrochemical cell is a designated diagnostic half-cell, said cell being in indirect contact with the measurement sample via one or more intervening liquid junctions.

6. A sensor as in claim 1, wherein one said electrochemical half-cell is designed to measure chemical changes in the diagnostic half-cell cell.

7. A sensor as in claim 1, further comprising a plurality of housings, preferably one wholly inside another.

8. A sensor as in claim 7, wherein the exterior housing is comprised of a conductive material, preferably of metal, and thereby suitable for a solution ground for said potential measurements.

9. A sensor as in claim 1, wherein one said electrochemical half-cell is used as a solution ground.

10. A sensor as in claim 1, wherein said exterior housing is comprised of a non-conductive material.

11. A sensor as in claim 1, wherein one said electrochemical half-cell is located external to said shell.

12. A sensor as in claim 1, wherein the voltage potential change between two said half-cells is converted to a measured change in chemical gradient.

13. The measurement of ion concentration of a sample using the sensor of claim 1.

14. The measurement of diagnostic half-cell degradation within the sensor of claim 1.

15. The use of the sensor of claim 1 to aid in the calibration of the ion measurement.

16. The use of the sensor of claim 1 in an automated mode for replacement of sensors when degradation limits are reached.

17. The use of the sensor of claim 1 in an alert mode for the alerting of operators to changes in cell potential.
